(19) United States
(12) Patent Application Publication
(10) Pub. No.: US 2017/0185971 A1
(43) Pub. Date: Jun. 29, 2017

(54) MAINTENANCE METHOD FOR FACILITY

(71) Applicant: Tokyo Electric Power Company Holdings, Incorporated, Tokyo (JP)

(72) Inventors: Shinichi MASUKO, Tokyo (JP); Tadayuki SAITOU, Tokyo (JP); Motohiro ISHIKAWA, Tokyo (JP); Yasuteru FUKUSHIMA, Tokyo (JP); Kazunari KASHIMA, Tokyo (JP); Chikara MOROOKA, Tokyo (JP); Kazuhiro FUTAKAWA, Tokyo (JP); Norihiro KUSAKA, Tokyo (JP); Hideki ENDOU, Tokyo (JP); Takashi KANAI, Tokyo (JP)

(73) Assignee: Tokyo Electric Power Company Holdings, Incorporated, Tokyo (JP)

(21) Appl. No.: 15/460,547

(22) Filed: Mar. 16, 2017

Related U.S. Application Data
(63) Continuation-in-part of application No. PCT/JP2014/081767, filed on Dec. 1, 2014.

(51) Int. Cl. G06Q 10/00; G06Q 10/10; G06Q 10/06

(52) U.S. Cl. CPC G06Q 10/20; G06Q 10/06316; G06Q 10/1097

(57) ABSTRACT

A facility maintenance method updates, in a case where an event having occurred in a facility is determined to fall outside a fault tree, the fault tree such that a cause of occurrence of the event identified through investigation is reflected, and in response to the identified cause of occurrence of the event, identifies a location where a structural element of equipment/material identified to relate to the cause of occurrence of the event is used, based on installation information indicating a location where the equipment/material is installed, to formulate an inspection plan for the identified location.

### BACKGROUND

Technical Fields

Embodiments of the present invention generally relate to a maintenance method for a facility.

Related Art

In related art, an electric power company maintains an electric power facility thereof to ensure a stable supply of electric power.

As an example, a failure state check system has been known such as one where a server receives data in regard to a watt-hour meter of a consumer when the consumer reports a failure of an electric power facility to display a cause of the failure in response to the received data, for example, refer to Japanese Unexamined Patent Application, First Publication No. 2008-22676.

Failures occurring in a facility such as an electric power facility include a failure that does not fall within any of known causes of occurrence of failures. When such a failure has occurred due to an unknown cause, in some cases, maintenance through a measure ended by, for example, merely replacing materials or equipment cannot effectively prevent a failure arising afterward from a similar cause from occurring. Accordingly, it is required to achieve effective maintenance in a facility by handling a failure occurring due to an unknown cause as well.

### SUMMARY

A facility maintenance method may include, but is not limited to, a fault tree determination step of determining whether an event having occurred in a facility falls within a fault tree indicating known causes of occurrence of events in equipment/material in the facility; a fault tree update step of, in a case where the event is determined to fall outside the fault tree, updating the fault tree such that a cause of occurrence of the event identified through investigation is reflected; a location identification step of, in response to the identified cause of occurrence of the event, identifying a location where a structural element of the equipment/material identified to relate to the cause of occurrence of the event is used, based on installation information indicating a location where the equipment/material is installed; and an inspection plan formation step of formulating an inspection plan for the identified location.

Further features and aspects of the present disclosure will become apparent from the following detailed description of exemplary embodiments with reference to the attached drawings.

### BRIEF DESCRIPTION OF THE DRAWINGS

FIG. 1 is a diagram illustrating an organizational structure of an electric power company handling the maintenance of an electric power facility according to an embodiment.

FIG. 2 is a diagram illustrating an exemplary configuration of a maintenance system for the electric power facility according to the embodiment.

FIG. 3 is a diagram illustrating an exemplary configuration of a failure-related information storage according to the embodiment.

FIG. 4 is a diagram illustrating an exemplary fault tree represented by fault tree information according to the embodiment.

FIG. 5 is a diagram illustrating an exemplary structure of equipment/material management information according to the embodiment.

FIG. 6 is a diagram illustrating an exemplary structure of installation information stored in accordance with a classification of equipment/material of a utility pole in the equipment/material management information according to the embodiment.

FIG. 7 is a diagram illustrating an exemplary structure of the installation information stored in accordance with a classification of equipment/material of a transformer/switch in the equipment/material management information according to the embodiment.

FIG. 8 is a diagram illustrating an exemplary structure of the installation information stored in accordance with a classification of equipment/material of an electric wire/cable in the equipment/material management information according to the embodiment.

FIG. 9 is a flowchart illustrating an exemplary procedure used in the maintenance system for the electric power facility according to the embodiment to handle a failure occurring in the electric power facility.

### DETAILED DESCRIPTION OF THE EMBODIMENTS

A facility maintenance method may include, but is not limited to, a fault tree determination step of determining whether an event having occurred in a facility falls within a fault tree indicating known causes of occurrence of events in equipment/material in the facility; a fault tree update step of, in a case where the event is determined to fall outside the fault tree, updating the fault tree such that a cause of occurrence of the event identified through investigation is reflected; a location identification step of, in response to the identified cause of occurrence of the event, identifying a location where a structural element of the equipment/material identified to relate to the cause of occurrence of the event is used, based on installation information indicating a location where the equipment/material is installed; and an inspection plan formation step of formulating an inspection plan for the identified location.

In the aforementioned facility maintenance method, the inspection plan formation step may calculate a priority of the identified location in regard to the inspection based on the degree of maintenance importance indicating a level of importance in maintenance determined for each of the identified locations, to formulate the inspection plan based on the calculated priority.

In the aforementioned facility maintenance method, the degree of maintenance importance may include the degree of security indicating a level of security required for an applicable location, and the inspection plan formation step may calculate a priority of the identified location in regard to the inspection based on the degree of security determined for each of the identified locations, to formulate the inspection plan based on the calculated priority.

In the aforementioned facility maintenance method, the degree of maintenance importance may include the degree of inconvenience indicating a level of inconvenience that occurs when a supply is interrupted, and the inspection plan formation step may calculate a priority of the identified location in regard to the inspection based on the degree of inconvenience determined for each of the identified locations, to formulate the inspection plan based on the calculated priority.

In the aforementioned facility maintenance method, the inspection plan formation step may determine an order of inspection for each of the identified locations based on the priority.

In the aforementioned facility maintenance method, the inspection plan formation step may determine whether the inspection is required for each of the identified locations based on the priority.

In the aforementioned facility maintenance method, the facility may be an electric power facility.

In the aforementioned facility maintenance method, in a case where the facility is the electric power facility, the inspection plan formation step may calculate a priority of the identified location in regard to the inspection based on the degree of maintenance importance indicating a level of importance in maintenance determined for each of the identified locations, to formulate the inspection plan based on the calculated priority.

In the aforementioned facility maintenance method, in a case where the facility is the electric power facility, the degree of maintenance importance may include the degree of security indicating a level of security required for an applicable location, and the inspection plan formation step may calculate a priority of the identified location in regard to the inspection based on the degree of security determined for each of the identified locations, to formulate the inspection plan based on the calculated priority.

In the aforementioned facility maintenance method, in a case where the facility is the electric power facility, the degree of maintenance importance may include the degree of inconvenience indicating a level of inconvenience that occurs when an electric power supply is interrupted, and the inspection plan formation step may calculate a priority of the identified location in regard to the inspection based on the degree of inconvenience determined for each of the identified locations, to formulate the inspection plan based on the calculated priority.

In the aforementioned facility maintenance method, in a case where the facility is the electric power facility, the inspection plan formation step may determine an order of inspection for each of the identified locations based on the priority.

In the aforementioned facility maintenance method, in a case where the facility is the electric power facility, the inspection plan formation step may determine whether the inspection is required for each of the identified locations based on the priority.

The term “facility” used in embodiments refers to every tangible thing, which can in generally be designed, constructed, built, manufactured, installed, and maintained for performing any purpose, activities or functions in human society. In some cases, the facility may include, but is not limited to, a permanent, semi-permanent or temporary commercial or industrial property such as building, plant, or structure for performing any purpose, activities or functions in human society.

The term “event” used in embodiments refers to something that happens such as a social occasion or activity.

The term “equipment” used in embodiments refers to a set of one or more tangible articles or physical resources such as, but not limited to, some structural or tangible elements, apparatus, devices, or implements used in an operation or activity; fixed assets other than land and buildings.

The term “equipment/material” used in embodiments refers to at least one of equipment and material, for example, equipment alone, material alone or in combination.

The term “fault tree analysis (FTA)” used in embodiments refers to a top down, deductive failure analysis in which an undesired state of a system is analyzed using Boolean logic to combine a series of lower-level events. This analysis method is mainly used in the fields of safety engineering and reliability engineering to understand how systems can fail, to identify the best ways to reduce risk or to determine (or get a feeling for) event rates of a safety accident or a particular system level (functional) failure.

Hereinafter, a facility maintenance method according to an embodiment will be described with reference to the drawings.

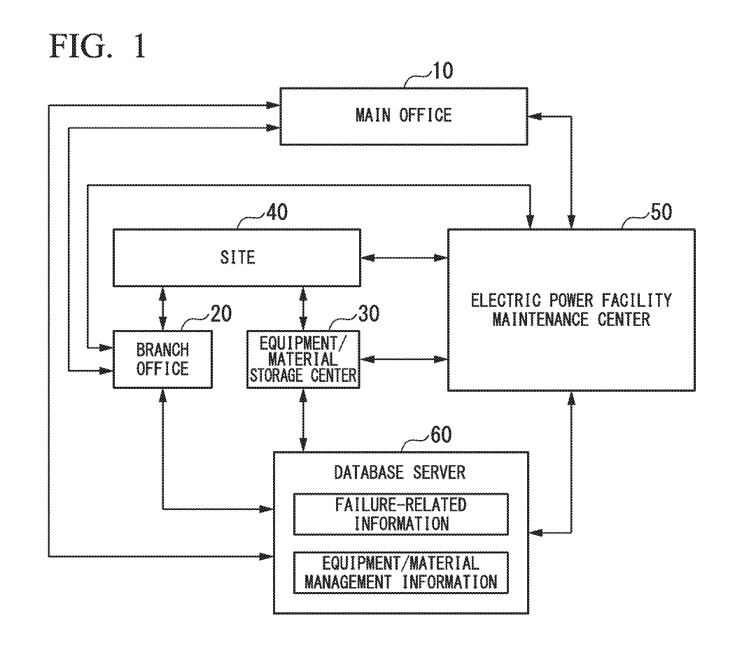

FIG. 1 is a diagram illustrating an organizational structure of an electric power company handling facility maintenance exemplified by the embodiment.

The organization illustrated in FIG. 1 includes a main office 10, a branch office 20, an equipment/material storage center 30, a site 40, an electric power facility maintenance center 50, and a database server 60.

The main office 10 corresponds to a head office of the electric power company owning an electric power facility to be maintained in the embodiment. The main office 10 approves a proposal and the like from, for example, the electric power facility maintenance center 50 in regard to the maintenance of the electric power facility. The main office 10 also instructs the branch office 20 in regard to the maintenance of the electric power facility, for example.

An entire region where the electric power company installs the electric power facilities is divided into a plurality of maintenance areas. The branch office 20 is provided for each of the maintenance areas and supervises the site 40 in the same maintenance area, for example.

For convenience in making the drawing simple and easy to understand, FIG. 1 illustrates one branch office 20 and one site 40 both corresponding to one maintenance area. However, the branch office 20 and the site 40 are provided for each of the plurality of maintenance areas.

The equipment/material storage center 30 stores equipment/materials to be installed at the respective sites 40. The equipment/material here indicates equipment and a material constituting the electric power facility. Examples of the material include a utility pole and various types of cables such as an electric wire. Examples of the equipment include a transformer, a switchboard, and the like. The equipment/material storage center 30 also stores equipment/materials collected from an applicable maintenance area due to a failure, aging, expiration of service life.

A worker works at the site 40 to maintain the electric power facility in the applicable maintenance area. The branch office 20 corresponding to the same maintenance area gives an instruction on work at the site 40. When work such as installation of new equipment/material or replacement of the equipment/material is required for the maintenance of the electric power facility, the worker at the site 40 transports necessary equipment/material to a work site from the equipment/material storage center 30. In addition, in a case where the equipment/material is collected because of partial removal of the electric power facility or replacement of the equipment/material, the worker at the site 40 may transport the collected equipment/material to the equipment/material storage center as necessary.

The electric power facility maintenance center 50 comprehensively manages the maintenance of the electric power facility for each of the maintenance areas. Here, in some cases, a cause of a failure serving as one of the events in the electric power facility occurring at the site 40 does not fall within any of known causes obtained as knowledge. In a case where such a failure occurs, the site 40, the branch office 20, or the like reports, to the electric power facility maintenance center 50, the occurrence of the failure that does not fall within any of known causes.

In response to such a report of the failure that has occurred due to an unknown cause, the electric power facility maintenance center 50 identifies the cause of occurrence thereof as a new cause by, for example, specifically investigating the equipment/material in which the failure has occurred. Upon identifying the cause of occurrence as a new cause, the electric power facility maintenance center 50 reflects the identified cause of occurrence of the failure in failure-related information stored in the database server 60. The electric power facility maintenance center 50 also determines a maintenance schedule for the electric power facility relating to the newly-identified cause of occurrence of the failure.

The database server 60 stores the failure-related information and equipment/material management information. The database server 60 is connected to the branch office 20, the equipment/material storage center 30, the electric power facility maintenance center 50, and the like through an intranet INT. The branch office 20, the equipment/material storage center 30, and the electric power facility maintenance center 50 can access the failure-related information and the equipment/material management information stored in the database server 60 via the intranet INT.

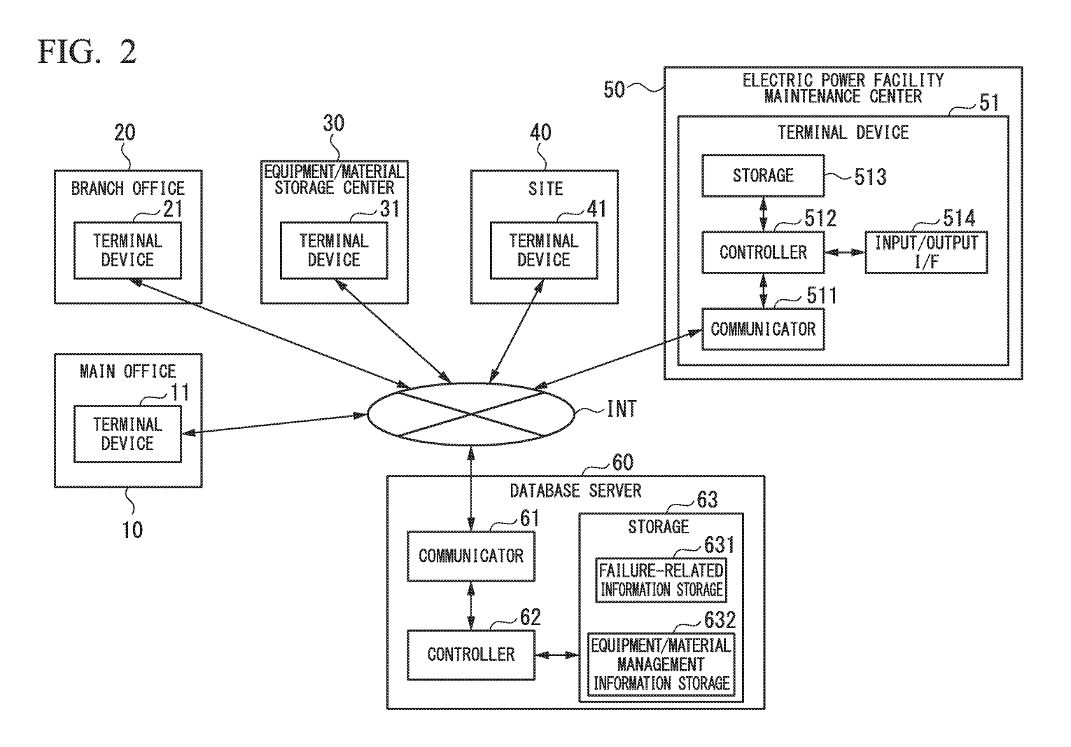

FIG. 2 illustrates an exemplary configuration of a maintenance system for the electric power facility according to the embodiment, which corresponds to the organization of the electric power company illustrated in FIG. 1. In FIG. 2, components same as those in FIG. 1 are denoted by reference numerals same as those in FIG. 1 and the description thereof will be omitted. As illustrated in FIG. 2, the maintenance system corresponding to the organization of the electric power company includes a terminal device 11 provided at the main office 10, a terminal device 21 provided at the branch office 20, a terminal device 31 provided at the equipment/material storage center 30, a terminal device 41 provided at the site 40, a terminal device 51 provided at the electric power facility maintenance center 50, and the database server 60. The terminal devices 11, 21, 31, 41, and 51 and the database server 60 are connected to each other so as to be communicable mutually via the intranet INT of the electric power company.

Note that FIG. 2 illustrates the single terminal devices 11, 21, 31, 41, and 51 for the main office 10, the branch office 20, the equipment/material storage center 30, the site 40, and the electric power facility maintenance center 50, respectively, for convenience in making the drawing simple. However, the terminal devices 11, 21, 31, 41, and 51 may be provided in plural numbers at the main office 10, the branch office 20, the equipment/material storage center 30, the site 40, and the electric power facility maintenance center 50, respectively.

An exemplary configuration of the terminal device 51 provided at the electric power facility maintenance center 50 will be described with reference to FIG. 2. The terminal device 51 illustrated in FIG. 2 includes a communicator 511, a controller 512, a storage 513, and an input/output I/F (interface) 514. The communicator 511 communicates with the other terminal devices 11, 21, 31, and 41 and the database server 60 via the intranet INT. The controller 512 is configured by including a central processing unit (CPU), a random access memory (RAM), and the like and carries out various types of control in the terminal device 51. The storage 513 serves as an auxiliary storage device of the controller 512 and stores a program executed by the CPU in the controller 512 as well as various types of data used by the controller 512. The input/output I/F 514 includes an input device, an output device, and the like. Examples of the input device include a mouse, a keyboard, a touch panel, a pen tablet, and a scanner. Meanwhile, examples of the output device include a display device (display), an audio output device, and a printer.

The controller 512 carries out predetermined control in accordance with information input through the input device in the input/output I/F 514.

The controller 512 also controls the output device in the input/output I/F 514 as necessary depending on a processing situation such that information is output therefrom.

Each of the terminal devices 11, 21, 31, and 41 in the main office 10, the branch office 20, the equipment/material storage center 30, and the site 40, respectively, can be also configured similarly to the terminal device 51.

Subsequently, an exemplary configuration of the database server 60 will be described with reference to same FIG. 2. The database server 60 illustrated in FIG. 2 includes a communicator 61, a controller 62, and a storage 63. The communicator 61 communicates with the terminal devices 11, 21, 31, 41, and 51 via the intranet INT. The controller 62 is configured by including a CPU, a RAM, and the like and carries out various types of control in the database server 60.

The storage 63 serves as an auxiliary storage device of the controller 62 and stores a program executed by the CPU in the controller 62 as well as various types of data used by the terminal devices 11, 21, 31, 41, and 51 within the maintenance system. The storage 63 according to the embodiment includes a failure-related information storage 631 and an equipment/material management information storage 632.

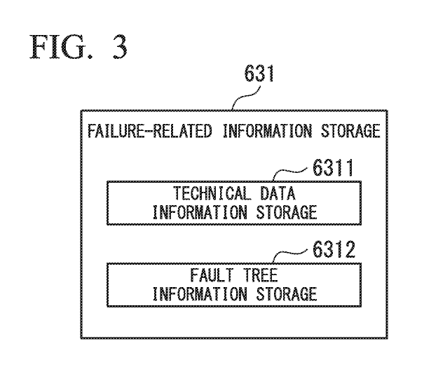

The failure-related information storage 631 stores the failure-related information. The failure-related information is information relating to failures in the electric power facility owned by the electric power company. As illustrated in FIG. 3, the failure-related information storage 631 includes a technical data information storage 6311 and a fault tree information storage 6312. The technical data information storage 6311 stores technical data information. The fault tree information storage 6312 stores fault tree information. Accordingly, the failure-related information stored in the failure-related information storage 631 includes the technical data information and the fault tree information.

The technical data information is information indicating a state of failure in regard to equipment/material for which a failure has been discovered in the past in the electric power facility. Specifically, the technical data information indicates information identifying equipment/material for which a failure has been discovered (e.g., a model number, manufacturer name), an installation location and installation date and time of equipment/material for which a failure has been discovered, a state in response to a failure in equipment/material for which a failure has been discovered, and the like.

The fault tree information is information indicating, as a fault tree form, causes of occurrence of failures identified from past failure cases which have occurred in the equipment/material in the electric power facility.

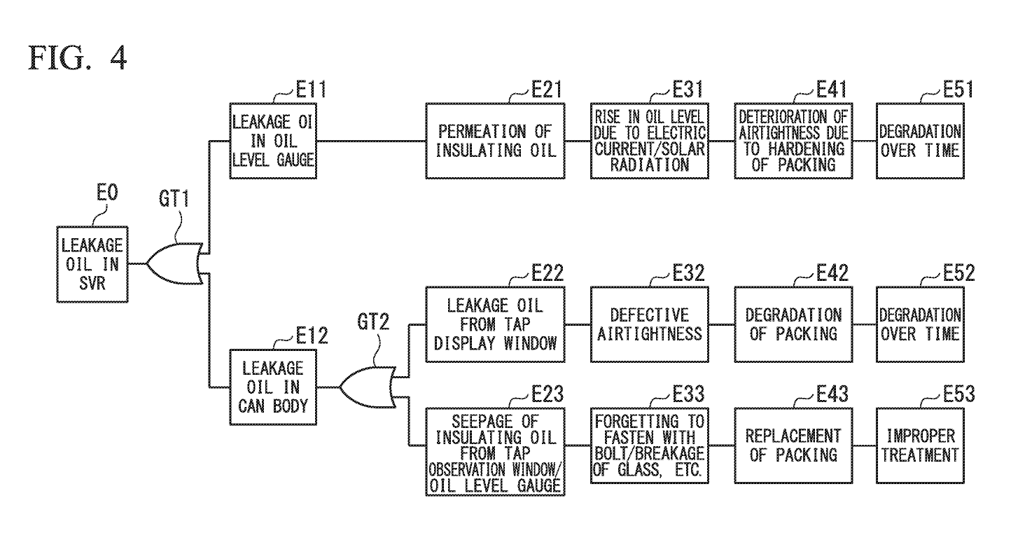

An exemplary fault tree represented by the fault tree information stored in the fault tree information storage 6312 will be described with reference to FIG. 4. The fault tree illustrated in FIG. 4 extracts part of the entire fault tree represented by the fault tree information to display a partial tree corresponding to a case where a failure has occurred in a step voltage regulator (SVR) due to a symptom of leakage oil.

The SVR is categorized into the equipment for the electric power facility and serves as a pole transformer. The SVR has a function as the pole transformer to raise a voltage lowered due to an electrical resistance present in an electric line.

In FIG. 4, “leakage oil in SVR” is arranged as a top event E0. Two first intermediate events E11 and E12 branched at an OR gate GT1 are arranged in a lower level of the top event E0, namely, “leakage oil in SVR”. The first intermediate event E11 corresponds to an event of “leakage oil in oil level gauge”. The first intermediate event E12 corresponds to an event of “leakage oil in can body”. Accordingly, the top event E0, the OR gate GT1, and the first intermediate events E11 and E12 indicate that a symptom of the failure “leakage oil in SVR” falls within at least one of the state “leakage oil in oil level gauge” and the state “leakage oil in can body”.

A second intermediate event E21, a third intermediate event E31, a fourth intermediate event E41, a basic event E51 are arranged in lower levels of the first intermediate event E11 in this order. The second intermediate event E21 indicates “permeation of insulating oil”. Accordingly, the second intermediate event E21 indicates that “leakage oil in oil level gauge” serving as the first intermediate event E11 occurs because of “permeation of insulating oil”.

In addition, the third intermediate event E31 indicates “rise in oil level due to electric current/solar radiation”. Accordingly, the third intermediate event E31 indicates that “permeation of insulating oil” serving as the second intermediate event E21 occurs because of “rise in oil level due to electric current/solar radiation”. Furthermore, the fourth intermediate event E41 indicates “deterioration of airtightness due to hardening of packing”. Accordingly, the fourth intermediate event E41 indicates that “rise in oil level due to electric current/solar radiation” serving as the third intermediate event E31 occurs because of “deterioration of airtightness due to hardening of packing”.

The basic event E51 indicates “degradation over time”. Accordingly, the basic event E51 indicates that “deterioration of airtightness due to hardening of packing” serving as the fourth intermediate event E41 occurs because of “degradation over time”.

Meanwhile, two second intermediate events E22 and E23 branched at an OR gate GT2 are arranged in a lower level of the first intermediate event E12. The second intermediate event E22 corresponds to an event of “leakage oil from tap display window”, whereas the second intermediate event E23 corresponds to an event of “seepage of insulating oil from tap observation window/oil level gauge”. Accordingly, the first intermediate event E12, the OR gate GT2, and the second intermediate events E22 and E23 indicate that “leakage oil in can body” occurs because of at least one of “leakage oil from tap display window” and “seepage of insulating oil from tap observation window/oil level gauge”.

In addition, a third intermediate event E32, a fourth intermediate event E42, a basic event E52 are arranged in lower levels of the second intermediate event E22 in this order. The third intermediate event E32 indicates “defective airtightness”. Accordingly, the third intermediate event E32 indicates that “leakage oil from tap display window” serving as the second intermediate event E22 occurs because of “defective airtightness”. The fourth intermediate event E42 indicates “degradation of packing”. Accordingly, the fourth intermediate event E42 indicates that “defective airtightness” serving as the third intermediate event E32 occurs because of “degradation of packing”. The basic event E52 indicates “degradation over time”. Accordingly, the basic event E52 indicates that “degradation of packing” serving as the fourth intermediate event E42 occurs because of “degradation over time”, which consequently indicates that a fundamental factor of the cause of occurrence of the leakage oil in the SVR is the degradation of the packing over time.

Meanwhile, a third intermediate event E33, a fourth intermediate event E43, a basic event E53 are arranged in lower levels of the second intermediate event E23 in this order. The third intermediate event E33 indicates “forgetting to fasten with bolt/breakage of glass, etc.”. Accordingly, the third intermediate event E33 indicates that “seepage of insulating oil from tap observation window/oil level gauge” serving as the second intermediate event E23 occurs because of “forgetting to fasten with bolt/breakage of glass, etc.”. The fourth intermediate event E43 indicates “replacement of packing”. Accordingly, the fourth intermediate event E43 indicates that “forgetting to fasten with bolt/breakage of glass, etc.” serving as the third intermediate event E33 occurs because work for “replacement of packing” has been carried out. The basic event E53 indicates “improper treatment”. Accordingly, the basic event E53 indicates that a fundamental factor of the cause of occurrence of the leakage oil in the SVR is “improper treatment” during the work for “replacement of packing” serving as the fourth intermediate event E43.

The description will continue by returning to FIG. 2. The equipment/material management information storage 632 in the storage 63 of the database server 60 stores the equipment/material management information. The equipment/material management information is information for managing the equipment/material installed as the electric power facility.

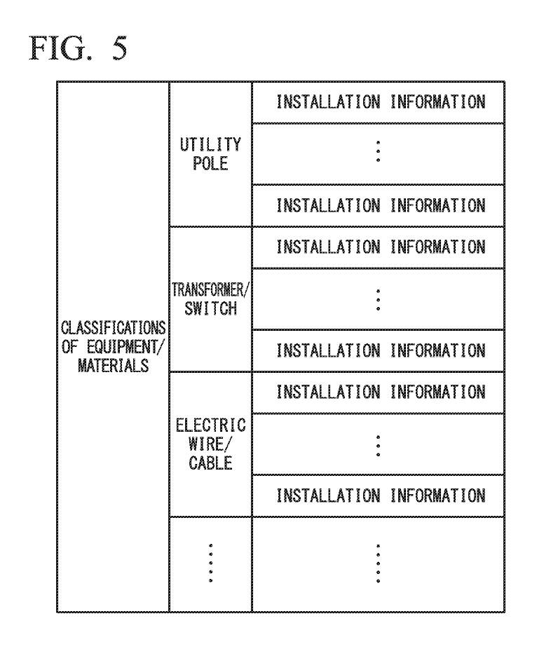

FIG. 5 illustrates an exemplary structure of the equipment/material management information. The equipment/material management information illustrated in FIG. 5 is categorized depending on predetermined respective classifications of equipment/materials. FIG. 5 illustrates an example of categorization into the classifications of equipment/materials such as a utility pole, a transformer/switch (a transformer or a switch), an electric wire/cable (an electric wire or a cable other than the electric wire), and the like. Based on such categorization, the equipment/material management information stores installation information on the respective classifications of the equipment/materials categorized as described above.

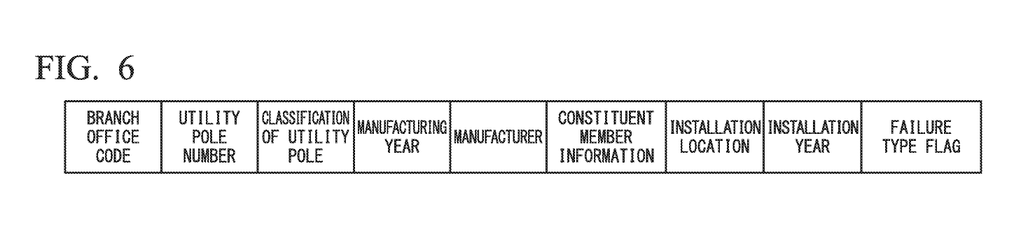

FIG. 6 illustrates an exemplary structure of the installation information stored in the equipment/material management information in accordance with the classification of equipment/material of the utility pole. The installation information illustrated in FIG. 6 includes regions for storing a branch office code, a utility pole number, a classification of utility pole, a manufacturing year, a manufacturer, structural element information, an installation location, an installation year, and a failure type flag.

The region for the branch office code stores a branch office code indicating a branch office 20 responsible for a maintenance area including a location where a utility pole serving as applicable equipment/material is installed. The region for the utility pole number stores a utility pole number given to the applicable utility pole. The utility pole number is a unique number given to each of the utility poles and functions as an identifier. The region for the classification of utility pole stores information indicating a classification of the applicable utility pole. The region for the manufacturing year stores information indicating a manufacturing year of the applicable utility pole. The region for the manufacturer stores information indicating a maker (manufacturer) that has manufactured the applicable utility pole.

The region for the structural element information stores structural element information indicating a structural element of the applicable utility pole. The structural element here means an element such as a material or a component constituting the equipment/material, specifically, the applicable utility pole. For example, the structural element information can be obtained by entering data indicating specifications of the applicable utility pole acquired from a supplier (e.g., the manufacturer of the utility pole) that delivers the utility pole.

The region for the installation location stores information indicating a location where the applicable utility pole has been installed (installation location). For example, the information indicating the installation location represents the installation location as an address. Alternatively, the information indicating the installation location may be represented using the latitude and the longitude. The region for the installation year stores information indicating a year when the applicable utility pole has been installed (installation year). Instead of the information on the installation year, information indicating a more specific time of installation may be stored such as a date when the applicable utility pole has been installed (installation date).

The region for the failure type flag stores a flag indicating a failure type within which the applicable utility pole falls (failure type flag) among classifications of failures (failure types) that have been known based on past failures in the equipment/material. The failure type flag corresponding to one failure type can be configured as a structure in which a failure type identifier indicating an applicable failure type is associated with a bit serving as a flag indicating whether the applicable failure type is relevant.

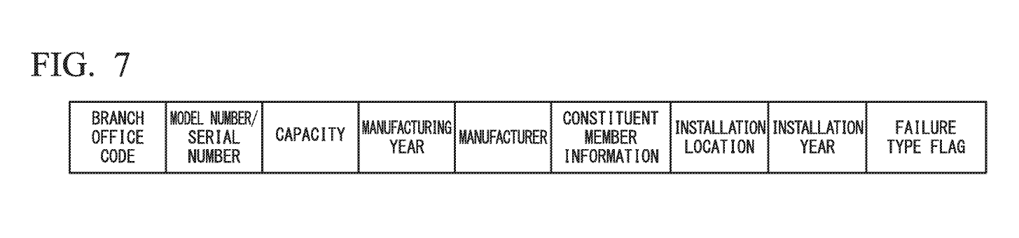

FIG. 7 illustrates an exemplary structure of the installation information stored in the equipment/material management information in accordance with the classification of equipment/material of the transformer/switch. The installation information corresponding to the transformer/switch illustrated in FIG. 7 includes regions for storing a branch office code, model number/serial number, a capacity, a manufacturing year, a manufacturer, structural element information, an installation location, an installation year, and a failure type flag.

The region for the branch office code stores a branch office code indicating a branch office 20 whose maintenance area includes a location where a transformer/switch (a transformer or a switch) serving as applicable equipment/material is installed. The region for the model number/serial number stores a model number and a serial number given to the applicable transformer/switch. The model number is a number indicating a model of the transformer/switch, whereas the serial number is a number given to the form specified by the model number in the order of manufacturing. Therefore, the transformer/switch is uniquely identified by the model number and the serial number. The capacity indicates a capacity provided in the applicable transformer/switch. The region for the manufacturing year stores information indicating a manufacturing year of the applicable transformer/switch. The region for the manufacturer stores information indicating a maker (manufacturer) that has manufactured the applicable transformer/switch.

The region for the structural element information stores structural element information indicating a structural element of the applicable transformer/switch. The structural element in the installation information on the transformer/switch refers to a component constituting the applicable transformer/switch. The region for the configuration information on the transformer/switch stores data indicating specifications of the applicable transformer/switch acquired from a supplier (e.g., the manufacturer of the transformer/switch) that delivers the transformer/switch.

The region for the installation location stores information indicating an installation location of the applicable transformer/switch. The region for the installation year stores information indicating a year when the applicable transformer/switch has been installed (installation year). Instead of the information on the installation year, for example, information indicating a more specific time of installation such as an installation date may be stored for the transformer/switch as well.

The region for the failure type flag stores a flag indicating a failure type within which the applicable transformer/switch falls (failure type flag) among classifications of failures (failure types) that have been known based on past failures in the equipment/material.

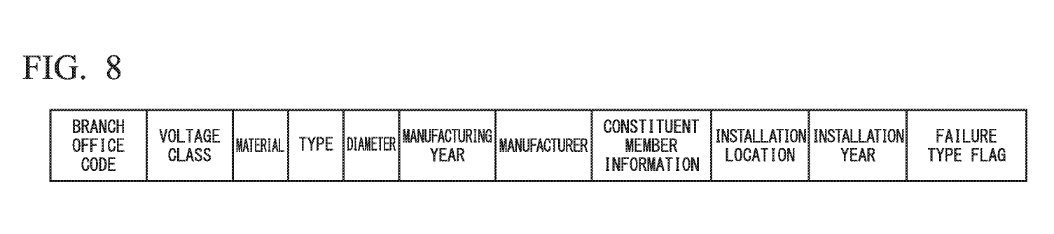

FIG. 8 illustrates an exemplary structure of the installation information stored in the equipment/material management information in accordance with the classification of equipment/material of the electric wire/cable. The installation information corresponding to the electric wire/cable illustrated in FIG. 8 includes regions for storing a branch office code, a voltage class, a material, a type, a diameter, a manufacturing year, a manufacturer, structural element information, an installation location, an installation year, and a failure type flag.

The region for the branch office code stores a branch office code indicating a branch office 20 whose maintenance area includes a location where an electric wire/cable (an electric wire or a cable) serving as applicable equipment/material is installed. The region for the voltage class stores information indicating which of a high voltage and a low voltage the applicable electric wire/cable is classed as in regard to a voltage withstanding standard. The region for the material stores information indicating a material of the applicable electric wire/cable. Examples of the material of the electric wire/cable include aluminum and copper. The region for the type stores information indicating a type of the applicable electric wire/cable. For example, the type of the electric wire/cable includes a type of slow snow accretion. The diameter stores information indicating a diameter of the applicable electric wire/cable. The region for the manufacturing year stores information indicating a manufacturing year of the applicable electric wire/cable. The region for the manufacturer stores information indicating a maker (manufacturer) that has manufactured the applicable electric wire/cable.

The region for the structural element information stores structural element information indicating a structural element of the applicable electric wire/cable. The structural element in the installation information on the electric wire/cable refers to a material or the like constituting the applicable electric wire/cable. The configuration information on the electric wire/cable can be also obtained by entering data indicating specifications of the applicable electric wire/cable acquired from a supplier (e.g., the manufacturer of the electric wire/cable) that delivers the electric wire/cable.

The region for the installation location stores information indicating an installation location of the applicable electric wire/cable. The region for the installation year stores information indicating a year when the applicable electric wire/cable has been installed (installation year). Instead of the information on the installation year, for example, information indicating a more specific time of installation such as an installation date may be stored for the electric wire/cable as well.

The region for the failure type flag stores a flag indicating a failure type within which the applicable electric wire/cable falls (failure type flag) among classifications of failures (failure types) that have been known based on past failures in the equipment/material.

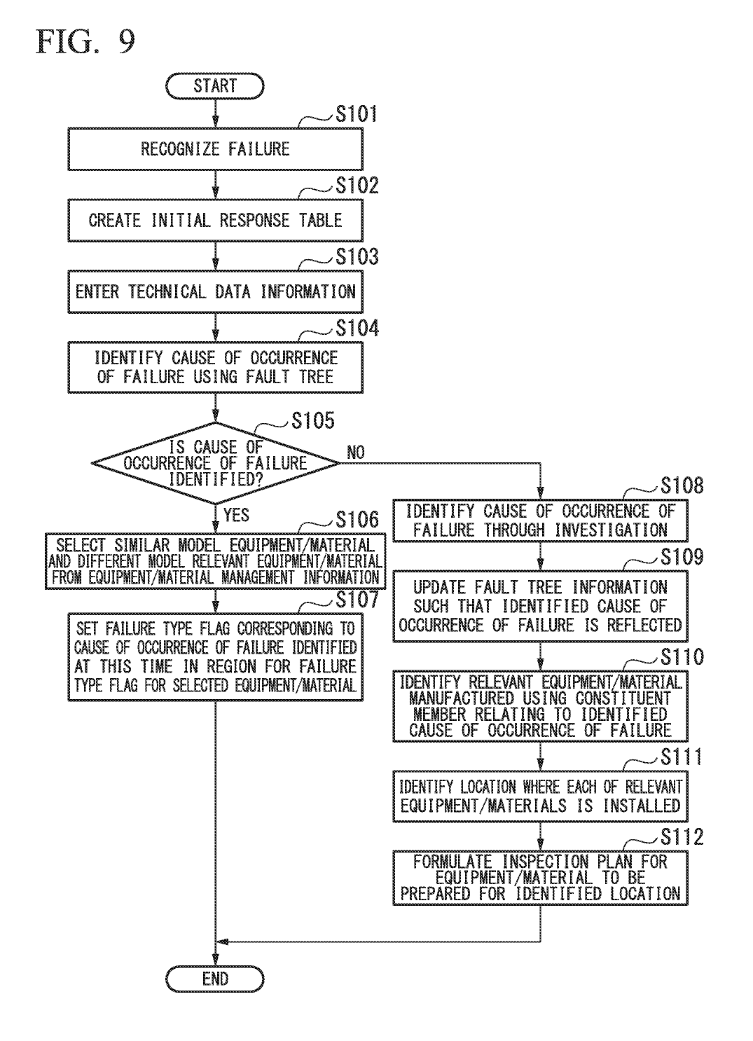

Subsequently, an exemplary procedure used in the maintenance system according to the embodiment to handle a failure occurring in the electric power facility will be described with reference to a flowchart in FIG. 9. First, a failure occurring in the electric power facility in an applicable maintenance area is recognized at the site 40 or the branch office 20 (step S101).

The recognition of the occurrence of the failure corresponding to step S101 is performed in several forms as follows. One form of the recognition of failure is recognition when an accident has occurred. Specifically, an accident such as a power breakdown occurs in the electric power facility and then the occurrence of the accident is reported to the site 40 or the branch office 20 through the maintenance system. As a result, the occurrence of the failure in the electric power facility is recognized. Another form of the recognition of failure is recognition due to a requested dispatch. The requested dispatch is required when a consumer such as an ordinary household contacts the electric power company in regard to a failure such as interruption of electric power supply. Mother form of the recognition of failure is recognition through patrol inspection at the site 40. The patrol inspection of the electric power facility is regularly carried out at the site 40. In some cases, an inspection worker discovers a failure that has occurred in the electric power facility during the patrol inspection. As described above, the failure is recognized because the inspection worker has discovered the failure during the patrol inspection.

Another form of the recognition of failure is recognition when a worker discovers a failure at the site 40 during construction work. Another form of the recognition of failure is recognition in response to a report to the site 40 or the branch office 20 from a person who discovers a failure such as an ordinary citizen regardless of being a worker at the site.

Another form of the recognition of failure is recognition in response to a case where a conveyancer of the equipment/material between the equipment/material storage center 30 and the site 40 discovers a failure during the work. In a case where the conveyancer of the equipment/material discovers a failure in equipment/material to be conveyed, the failure is reported to an administrator at the site 40, the branch office 20, or the like. The failure is recognized through such a report. Another form of the recognition of failure is recognition in response to a case where a meter reader discovers a failure at the site 40 during visiting a house of a consumer to read a meter. Note that the forms of the recognition of failure are not limited to the aforementioned examples.

Once the occurrence of failure is recognized, the worker at the site 40 collects equipment/material in which the failure has occurred (hereinafter, also referred to as equipment/material to be inspected) in the electric power facility. Following this, the worker at the site 40 creates an initial response table listing predetermined items in regard to the collected equipment/material (step S102). The items to be listed in the initial response table include a classification, a model, a physical state in response to the failure (for example, a state of damage due to heat generation) of the equipment/material to be inspected.

Here, for example, the initial response table may be created on an initial response table prepared as a paper sheet by the worker at the site 40 making necessary entries using something to write with. Alternatively, for example, the initial response table may be created by the worker at the site 40 using the terminal device 41. Specifically, a template file of the initial response table is stored in the terminal device 41. The worker at the site 40 opens the template file of the initial response table and makes necessary entries in the opened file of the initial response table through input operation to the terminal device 41 to create the initial response table. The initial response table created in step S102 is passed to the branch office 20.

Once the initial response table is passed to the branch office 20, the branch office 20 creates the technical data information indicating technical data of the equipment/material corresponding to the passed initial response table (step S103). The technical data indicated in the technical data information includes a type and specifications of the equipment/material, and information on the failure indicated in the initial response table.

The technical data information is created by a maintenance worker at the branch office 20 using the terminal device 21. Specifically, a template file of the technical data information is stored in the terminal device 21. The maintenance worker at the branch office 20 operates the terminal device 21 to make necessary entries in the template file of the technical data information. As described above, the technical data information is created for the equipment/material to be inspected.

The created technical data information is transmitted to the database server 60 from the terminal device 21 at the branch office 20 via the intranet INT. The controller 62 in the database server 60 stores the received technical data information to the technical data information storage 6311 (FIG. 3) included in the failure-related information storage 631 in the storage 63.

Thereafter, a cause of occurrence of the failure in the equipment/material to be inspected is identified at the site 40 using the fault tree represented by the fault tree information stored in the fault tree information storage 6312 of the database server 60 (step S104). Specifically, the cause of occurrence of the failure is identified in step S104 as described in the following example. The worker at the site 40 operates the terminal device 41 to download the fault tree information to the terminal device 41 from the database server 60. The worker displays, on the terminal device 41, a fault tree diagram based on the fault tree information downloaded to the terminal device 41. Alternatively, the worker may print the fault tree diagram based on the fault tree information to output from the terminal device 41. The worker applies a state of the equipment/material in which the failure has occurred to the fault tree diagram output as a display or a print as described above sequentially from the top event to the events in the lower levels to thereby identify the cause of occurrence of the failure.

Thereafter, as a result of attempting to identify the cause of occurrence of the failure in step S104 as described above, whether the cause of occurrence of the failure has been identified is determined at the site 40 (step S105). Step S105 is an example of a fault tree determination step for determining whether an event to be inspected that has occurred in the electric power facility falls within the fault tree indicating known causes of occurrence of events in the electric power facility. Specifically, in a case where the state of the equipment/material to be inspected falls within the fault tree and lastly arrives at a single basic event in the fault tree through the work in step S104 for identifying the cause of occurrence of the failure, the cause of the failure is determined to be identified. On the other hand, in a case where no more events applicable to the state of the equipment/material to be inspected are found during a process of tracing the events in the fault tree and arriving at the basic event is blocked, the cause of the failure is not determined to be identified.

When the cause of the failure is identified (step S105: YES), the failure in the equipment/material to be inspected is determined as a failure having occurred due to a known cause. As described above, in a case where the failure in the equipment/material to be inspected has occurred due to a known cause, the site 40 makes a failure occurrence report describing that situation (known failure occurrence report) to the branch office 20 in the applicable maintenance area. Specifically, the known failure occurrence report is at least required to communicate, from the site 40 to the branch office 20, information identifying the model of the equipment/material in which the failure has occurred such as the model number and information indicating the classification of the cause of occurrence of the failure (failure type).

In regard to the known cause of occurrence, the failure type is assigned to each of the causes of occurrence represented as the basic events in the fault tree diagram. The aforementioned information indicating the failure type simply indicates one of the failure types assigned to the fault tree. In regard to the known failure occurrence report from the site 40 to the branch office 20, data including details of the known failure occurrence report can be transmitted to the terminal device 21 at the branch office 20 from the terminal device 41 at the site 40. Alternatively, the known failure occurrence report from the site 40 to the branch office 20 may be transmitted via a telephone, a facsimile, a postal mail, or the like.

Upon receiving the aforementioned known failure occurrence report, the branch office 20 selects, from the equipment/material management information stored in the equipment/material management information storage 632 in the database server 60, similar model equipment/material and different model relevant equipment/material corresponding to the equipment/material to be inspected which is indicated in the known failure occurrence report (step S106). The similar model equipment/material is equipment/material of a model similar to that of the equipment/material to be inspected. The similar models here mean equipment/materials, for example, having similar model numbers to each other from the same manufacturer. Such equipment/materials are manufactured through similar processes using similar materials and similar model components. Accordingly, the similar model equipment/material selected in step S106 has a high possibility of a failure due to a cause similar to the one identified in step S105 at this time. Meanwhile, the different model relevant equipment/material is equipment/material that is not of a model similar to that of the equipment/material to be inspected for which the occurrence of the failure has been recognized in step S101 but manufactured using structural elements (materials and components) relating to the cause of occurrence of the failure identified for the equipment/material to be inspected. Such different model relevant equipment/material also has a high possibility of a failure due to a cause similar to the one identified in step S105 at this time.

The similar model equipment/material and the different model relevant equipment/material can be selected in step S106 as information processing in the terminal device 21 at the branch office 20 as will described hereinafter. The following description uses an example where the classification of the equipment/material to be inspected is a transformer. First, the similar model equipment/material is selected as follows. Upon receiving data of the known failure occurrence report transmitted from the terminal device 41 at the site 40, the terminal device 21 at the branch office 20 extracts information indicating a model of the equipment/material to be inspected (model information) from the received data of the known failure occurrence report. The model information extracted here at least includes a model number of the transformer serving as the equipment/material to be inspected. The terminal device 21 accesses the equipment/material management information stored in the equipment/material management information storage 632 of the database server 60. The terminal device 21 carries out processing of selecting, from the equipment/material management information being accessed, the installation information including the model number specified by the extracted model information. Equipment/material (transformer) corresponding to the installation information selected as described above is the similar model equipment/material. In other words, selecting the installation information including the model number specified by the model information selects the similar model equipment/material.

Meanwhile, as described below, the terminal device 21 selects the different model relevant equipment/material which is of a model different from that of the equipment/material to be inspected but includes the same structural element. Upon receiving data of the known failure occurrence report transmitted from the terminal device 41 at the site 40, the terminal device 21 extracts information indicating a structural element (e.g., a material or a component) relating to the cause of occurrence of the failure in the equipment/material to be inspected (relevant structural element information) from the received data of the known failure occurrence report.

Specifically, the structural element relating to the cause of occurrence of the failure here is a structural element acting as a fundamental factor of the cause of occurrence of the failure. For example, a transformer which has stopped working normally due to burnout has been investigated and a cause leading to the burnout has been identified as that a specific element in the transformer has been a defected product and that specific element has generated heat. In this case, the defect of the specific element acts as a fundamental factor of the cause of occurrence of the failure in the transformer. Accordingly, the structural element relating to the cause of occurrence of the failure is the specific element.

The terminal device 21 accesses the equipment/material management information stored in the equipment/material management information storage 632 of the database server 60. The terminal device 21 selects, from the equipinent/material management information being accessed, the installation information storing the structural element information including the structural element specified by the extracted relevant structural element information. Equipment/material (transformer) corresponding to the installation information selected as described above is the different model relevant equipment/material which is of a model different from that of the equipment/material to be inspected but includes the same structural element. In other words, according to the embodiment, by selecting, from the equipment/material management information, the installation information storing the structural element information including the structural element specified by the relevant structural element information, the different model relevant equipment/material is selected.

The similar model equipment/material and the different model relevant equipment/material can be also selected by the maintenance worker at the branch office 20 through the operation of the terminal device 41 as described below. The following description also uses the example where the classification of the equipment/material to be inspected is a transformer. In this case, the maintenance worker receives the known failure occurrence report from the site 40. The known failure occurrence report in this case is simply received in such a manner that the known failure occurrence report transmitted from the terminal device 41 at the site 40 is received by the terminal device 21 at the branch office 20. Alternatively, as described earlier, telephone contact, a postal mail, a facsimile, or the like from the site 40 may be used as a method for receiving the known failure occurrence report.

The maintenance worker at the branch office 20 operates the terminal device 21 to access the equipment/material management information stored in the equipment/material management information storage 632 of the database server 60 using the terminal device 21. When the terminal device 21 accesses the equipment/material management information, the equipment/material management information is displayed on the display in the input/output interface of the terminal device 21.

The maintenance worker selects the similar model equipment/material from the displayed equipment/material management information as follows. The maintenance worker learns the model of the transformer to be inspected based on the known failure occurrence report received from the site 40. The maintenance worker then selects, from the displayed equipment/material management information, the installation information on a transformer of a model similar to the learned model. In order to select the installation information, for example, the maintenance worker can enter a text string of the learned model as a search key to cause the terminal device 21 to carry out a search in the displayed equipment/material management information.

Meanwhile, the maintenance worker selects the different model relevant equipment/material from the displayed equipment/material management information as follows. Based on the known failure occurrence report received from the site 40, the maintenance worker selects the installation information containing the structural element information including a structural element similar to the structural element relating to the cause of occurrence of the failure in the transformer to be inspected. The installation information selected as described above corresponds to the different model relevant equipment/material.

Thereafter, the branch office 20 sets the failure type flag indicating the cause of occurrence of the failure identified in step S104 at this time in the region for the failure type flag in the installation information on the equipment/material (the similar model equipment/material or the different model relevant equipment/material) selected in step S106 (step S107). The procedure in step S107 can be carried out through the information processing in the terminal device 21 at the branch office 20. Alternatively, the procedure in step S107 can be also carried out by the maintenance worker operating the terminal device 21 to set the failure type flag.

The failure type flag is set in the region for the failure type flag in the installation information as described above, thereby indicating which one of the known failure cases the equipment/material corresponding to the installation information falls within. With this, associations between the equipment/material that has been already installed and the known failure cases can be recognized, making it possible to efficiently maintain the equipment/material that has been already installed in the electric power facility.

On the other hand, in a case where the state of the equipment/material to be inspected does not fall within the fault tree diagram and the cause of occurrence of the failure is not identified (step S105: NO), the failure that has occurred in the equipment/material to be inspected is determined as a case having occurred due to an unknown cause. In this case, the site 40 makes a failure occurrence report describing that the failure case has occurred due to an unknown cause of occurrence (unknown failure occurrence report) to the electric power facility maintenance center 50. The unknown failure occurrence report includes information indicating a model and an installation location of the equipment/material in which the failure has occurred. Additionally, the unknown failure occurrence report may include a situation in the installation location of the equipment/material when the failure occurred, and a state confirmed by the worker at the site 40 in regard to the equipment/material in which the failure has occurred.

Furthermore, the equipment/material to be inspected for which the cause of occurrence of the failure has not been identified is collected from the site 40 and transferred to the electric power facility maintenance center 50. The electric power facility maintenance center 50 investigates the equipment/material to be inspected to identify the cause of occurrence of the failure (step S108). The investigation for identifying the cause of occurrence of the failure here includes maintenance worker's work for inspecting the physical state to identify the cause by, for example, disassembling the actual equipment/material to be inspected. The investigation for identifying the cause of occurrence of the failure also includes maintenance worker's work for analyzing and simulating the equipment/material to be inspected to identify the cause.

The electric power facility maintenance center 50 updates the fault tree information such that the cause of occurrence of the failure identified in step S108 is reflected (step S109). Step S109 is an example of a fault tree update step for, in a case where an event to be inspected is determined to fall outside the fault tree, updating the fault tree such that a cause of occurrence of the event to be inspected which has been identified through investigation is reflected.

In step S109, specifically, the maintenance worker at the electric power facility maintenance center 50 operates the terminal device 51 to access the fault tree information stored in the fault tree information storage 6312 of the database server 60 using the terminal device 51. Accessing the fault tree information using the terminal device 51 as described above makes it possible to edit the fault tree information through the operation of the terminal device 51. When the fault tree information is edited, an edit screen for the fault tree information is displayed on the display of the terminal device 51 such that the maintenance worker edits the fault tree information through the operation on the edit screen.

While the editing of the fault tree information is available as described above, the maintenance worker operates the terminal device 51 to carry out editing work such that the cause of occurrence of the failure identified in step S108 is reflected in the fault tree information. In a specific example of the editing work, a branch point corresponding to the cause of occurrence of the failure identified in step S108 is added to the fault tree diagram displayed on the edit screen based on the fault tree information and then an event identified in response to the identified cause of occurrence of the failure is assigned to the added branch point. Thereafter, once the editing is completed, the maintenance worker updates the fault tree information stored in the fault tree information storage 6312 to reflect the final editing result.

In the aforementioned example, the fault tree information is updated by the maintenance worker operating on the edit screen to edit the fault tree. As an alternative to this, the fault tree information may be updated as described below. For example, the maintenance worker operates the terminal device 51 to input therein data such as a classification of the equipment/material to be inspected and a parameter corresponding to the identified cause of occurrence of the failure. The terminal device 51 uses the input data to carry out processing for modifying the fault tree information stored in the fault tree information storage 6312 such that the identified cause of occurrence of the failure is reflected.

In response to the identification of a new cause of occurrence of the failure in step S108, some electric power facility maintenance centers 50 formulate inspection plans as follows in addition to the update of the fault tree information described above. In order to formulate the inspection plan, the electric power facility maintenance center 50 identifies equipment/material manufactured using a structural element relating to the cause of occurrence of the failure identified in step S108 (relevant equipment/material) (step S110).

For this purpose, the maintenance worker at the electric power facility maintenance center 50 operates the terminal device 51 to access the equipment/material management information stored in the equipment/material management information storage 632 of the database server 60 using the terminal device 51. With this, the equipment/material management information is made available for processing in the terminal device 51. In this state, the maintenance worker operates the terminal device 51 to enter, as a search key, the structural element relating to the cause of occurrence of the failure identified in step S108. The terminal device 51 carries out processing in response to input of the search key to search the equipment/material management information for the installation information storing the structural element information including the structural element entered as the search key. Equipment/material corresponding to the installation information searched for through the aforementioned search processing by the terminal device 51 is the relevant equipment/material. As described above, step S110 identifies the relevant equipment/material by searching the equipment/material management information for the installation information.

Alternatively, the maintenance worker at the electric power facility maintenance center 50 may identify the relevant equipment/material in step S110 as follows. The maintenance worker prepares a specification sheet listing the specifications of the equipment/material installed in the applicable maintenance area. Structural elements such as a material and a component in use are recorded in the specification sheet as the specifications of the equipment/material installed in the applicable maintenance area. The maintenance worker then checks the structural element in use against the structural element relating to the cause of occurrence of the failure identified in step S108 for each of the equipment/material recorded in the specification sheet. In this manner, the maintenance worker looks for, in the specification sheet, the equipment/material in which a structural element similar to the structural element relating to the cause of occurrence of the failure identified in step S108 is used. By finding such equipment/material in the specification sheet as described above, the relevant equipment/material is identified.

Here, the relevant equipment/material identified as described above includes the structural element acting as a fundamental factor of the cause of occurrence of the failure in the equipment/material that has been investigated. Accordingly, the relevant equipment/material identified in step S110 includes the similar model equipment/material and the different model relevant equipment/material corresponding to the equipment/material that has been investigated in step S108. In some cases, however, even when equipment/material includes the structural element acting as a fundamental factor of the cause of occurrence of the failure in the equipment/material that has been investigated, a causal relationship resulting in a failure of a classification similar to that of the equipment/material that has been investigated does not exist in some equipment/materials because of, for example, a difference in a structure in the case of the different model relevant equipment/material. For a solution to this case, for example, when the relevant equipment/material is identified in step S110, the identification can be carried out for the similar model equipment/material by excluding the different model relevant equipment/material from the identification.

Thereafter, the electric power facility maintenance center 50 identifies a location where each of the relevant equipment/materials identified in step S110 is installed (step S111). Step S111 is an example of a location identification step for, in response to the identified cause of occurrence of an event to be inspected, identifying a location where a structural element of the equipment/material which has been identified to relate to the cause of occurrence of the event to be inspected is used, based on the installation information indicating an installation location of each of the equipment/materials.

In a case where the terminal device 51 has searched the equipment/material management information for the installation information in step S110, a location where each of the relevant equipment/materials is installed is identified by the terminal device 51 in step S111. Specifically, the controller 512 in the terminal device 51 acquires an installation location stored in the installation information searched for in step S110. The installation information searched for in step S110 corresponds to the relevant equipment/material. Accordingly, by acquiring the installation location stored in the installation information searched for in step S110, the controller 512 can identify a location of each of the relevant equipment/materials.

Alternatively, a location where each of the relevant equipment/materials is installed can be identified by the maintenance worker at the electric power facility maintenance center 50 in step S111 through the following work. Specifically, the maintenance worker confirms, in the equipment/material management information output from the terminal device 51, for example, as a display or a print, the installation location included in the installation information on the relevant equipment/material identified in step S110. The location where the relevant equipment/material is installed is also identified through such work by the maintenance worker.

Furthermore, the electric power facility maintenance center 50 formulates an inspection plan for the equipment/material to be prepared for the location identified in step S11 (step S112). Step S112 is an example of an inspection plan formation step for formulating an inspection plan for the identified location.

En a specific example of an aspect of formulating the inspection plan in step S112, the electric power facility maintenance center 50 can determine, based on the degree of maintenance importance determined for the identified location where the relevant equipment/material is installed, an order of inspecting the locations where the relevant equipment/materials are installed. The degree of maintenance importance indicates a level of importance in maintenance in the applicable location. In the embodiment, the degree of maintenance importance is defined as at least one of the degree of security and the degree of inconvenience. The degree of security indicates a level of security required for the applicable location. For example, the degree of security is high in a region such as an urban area where there are many people. The degree of inconvenience indicates a level of inconvenience that occurs when an electric power supply is interrupted. For example, the degree of inconvenience is high in a facility such as a hospital compared to an ordinary house or the like because proper medical treatment cannot be provided when the electric power supply is interrupted.

Considering this situation, the electric power facility maintenance center 50 according to the embodiment uses at least one of the degree of security and the degree of inconvenience to calculate a priority in regard to the inspection (inspection priority). Here, the calculation of the inspection priority corresponds to the determination of a priority order in regard to the inspection. The electric power facility maintenance center 50 then determines the order of inspecting the locations where the relevant equipment/materials are installed based on the calculated inspection priority in descending order. As described above, the order of inspecting the locations where the relevant equipment/materials are installed is determined based on the inspection priority obtained by using the degree of maintenance importance. As a result, the equipment/material can be inspected in a proper order in accordance with security or an amount of influence when the electric power supply is interrupted.

In a case where the inspection priority is obtained using both of the degree of security and the degree of inconvenience, a formula in which each of the degree of security and the degree of inconvenience is weighted may be used to obtain the inspection priority. In an example of this case, assuming that the degree of security is r1, a weighting coefficient for the degree of security is w1, the degree of inconvenience is r2, and a weighting coefficient for the degree of inconvenience is w2, an inspection priority R can be obtained using the following formula 1.

R=(r1×w1)+(r2×w2) (Formula 1)

The formation of the inspection plan based on the degree of security and the degree of inconvenience as described above can be realized through processing by the controller 512 in the terminal device 51. In this case, data for the respective locations identified in step S111 and data for each of the degree of security and the degree of inconvenience determined for the respective identified locations are input to the controller 512 of the terminal device 51. In the structure of the installation information in the equipment/material management information illustrated in FIGS. 6 to 8, for example, the data for the degree of security and the data for the degree of inconvenience can be associated with the information indicating the location and stored in the region for the installation location. Alternatively, a database may be created separately from the equipment/material management information to associate the respective installation locations of the equipment/materials with the data for the degree of security and the data for the degree of inconvenience and then stored in the storage 63 of the database server 60.

Subsequently, the controller 512 of the terminal device 51 uses the input data to calculate the inspection priority and determines the order of inspection for the locations identified in step S111 based on the calculated inspection priority. Additionally, in such a case that a period for inspecting the locations identified in step S11 is already determined, the controller 512 may estimate a travel time or the like by consulting map information to determine a time schedule of inspection as well based on the determined order of inspection.

Meanwhile, the inspection priority obtained based on the degree of maintenance importance may be used for the formation of the inspection plan other than the determination of the order of inspection. For example, the controller 512 of the terminal device 51 may determine whether the inspection is required for the respective locations identified in step S111 based on the inspection priority. Specifically, the controller 512 can formulate such an inspection plan that the inspection is required for a location with the inspection priority or the priority order based on the inspection priority equal to or higher than a certain level, whereas the inspection is not necessarily required for a location with the inspection priority or the priority order based on the inspection priority lower than the certain level. In addition to this, the controller 512 may further determine the order of inspection based on the inspection priority for the locations determined to be subjected to the inspection since the inspection priority or the priority order based on the inspection priority is deemed to be equal to or higher than the certain level.

The inspection plan can be also formulated based on the degree of security and the degree of inconvenience as described above through work by the maintenance worker at the electric power facility maintenance center 50.

FIG. 2 illustrates an example where the failure-related information and the equipment/material management information are stored in the same database server 60. However, the failure-related information and the equipment/material management information may be stored in separate servers individually.

The description thus far uses an example where the electric power facility serves as a facility to be maintained. However, a facility to be maintained in the embodiment is not limited to the electric power facility and may be an infrastructure such as a gas facility, a water facility, or a communication facility.

The processing by the terminal devices 11, 21, 31, 41, and 51 and the database server 60 described above may be carried out by recording, to a computer-readable recording medium (storage medium), a program for realizing the functions of the terminal devices 11, 21, 31, 41, and 51 and the database server 60 described above and then causing a computer system to read the program recorded in this recording medium to execute. Here, “causing a computer system to read the program recorded in the recording medium to execute” includes installation of the program to the computer system. The “computer system” here includes an OS and hardware such as a peripheral device. The “computer system” may also include a plurality of computer devices connected to each other through a network including a communication line such as the Internet, a WAN, a LAN or a dedicated line. Meanwhile, the “computer-readable recording medium” refers to a portable medium such as a flexible disk, a magneto-optical disk, a ROM, and a CD-ROM, or a storage device such as a hard disk built in the computer system. As described above, the recording medium storing the program may be a non-transitory computer-readable recording medium such as a CD-ROM. The recording medium also includes internal and external recording media capable of being accessed from a distribution server that distributes the aforementioned program. A code of a program stored in a recording medium of the distribution server may differ from a code of a program in a format executable by the terminal device. In other words, any format can be used to store the program in the distribution server as long as the program can be downloaded from the distribution server and installed in the terminal device in an executable format. Additionally, the program may be configured to be divided into plural pieces and later integrated in the terminal device after being downloaded at different timings from each other, and meanwhile the divided programs may be distributed from different distribution servers from each other. Furthermore, the “computer-readable recording medium” also includes a recording medium that holds the program for a certain time period such as a volatile memory (RAM) within a server or the computer system serving as a client in a case where the program is transmitted through a network. In addition, the aforementioned program may be configured to realize part of the aforementioned functions. The aforementioned program may also be a program capable of realizing the aforementioned functions by being combined with a program already recorded in the computer system, that is, a so-called difference file (difference program).

The apparatus, systems and methods in the above-described embodiments may be deployed in part or in whole through machines, a system of circuits, circuitry, hardware processors that executes computer software, software components, program codes, and/or instructions on one or more machines, a system of circuits, circuitry, hardware processors. In some cases, the one or more machines, a system of circuits, circuitry, hardware processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more hardware processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more hardware processors may enable execution of multiple programs, threads, and codes. The threads may be executed simultaneously to enhance the performance of the one or more hardware processors and to facilitate simultaneous operations of the application. Program codes, program instructions and the like described herein may be implemented in one or more threads. The one or more hardware processors may include memory that stores codes, instructions and programs as described herein. The machines, a system of circuits, circuitry, hardware processors may access a non-transitory processor-readable storage medium through an interface that may store codes, instructions and programs as described herein and elsewhere. The non-transitory processor-readable storage medium associated with the machines, a system of circuits, circuitry, hardware processors for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods, apparatus and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods, apparatus and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, CPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

As used herein, the following directional terms “front, back, above, downward, right, left, vertical, horizontal, below, transverse, row and column” as well as any other similar directional terms refer to those instructions of a device equipped with embodiments of the present invention. Accordingly, these terms, as utilized to describe embodiments of the present invention should be interpreted relative to a device equipped with embodiments of the present invention.

Each element for the system, device and apparatus described above can be implemented by hardware with or without software. In some cases, the system, device and apparatus may be implemented by one or more hardware processors and one or more software components wherein the one or more software components are to be executed by the one or more hardware processors to implement each element for the system, device and apparatus. In some other cases, the system, device and apparatus may be implemented by a system of circuits or circuitry configured to perform each operation of each element for the system, device and apparatus.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A facility maintenance method comprising:
performing a fault tree update to update the fault tree to reflect a cause of occurrence of an event identified through investigation, in a case that it is determined that the event having occurred in a facility falls outside a fault tree indicating causes of occurrence of known events in equipment or material in the facility;
identifying equipment or material which is identical in attribute to equipment or material which has been identified to be related to the cause of occurrence of the event, in response to having identified the cause of occurrence of the event;
identifying equipment or material which includes at least a structural element which is identical to a structural element which has been identified to be related to the cause of occurrence of the event, by using a structural element information indicating structural elements of each equipment or material;
identifying a location, where the equipment or material identified is used, based at least in part on installation information indicating a locations where the equipment or material is installed and an attribute of the equipment or material; and
making an inspection plan for the location identified.

2. The facility maintenance method according to claim 1, wherein
making the inspection plan formation comprises calculating a priority of the identified location in regard to the inspection based on the degree of maintenance importance indicating a level of importance in maintenance determined for each of the identified locations, to formulate the inspection plan based on the calculated priority.

3. The facility maintenance method according to claim 2, wherein
the degree of maintenance importance includes the degree of security indicating a level of security required for an applicable location, and
making the inspection plan formation comprises calculating a priority of the identified location in regard to the inspection based on the degree of security determined for each of the identified locations, to formulate the inspection plan based on the calculated priority.

4. The facility maintenance method according to claim 2, wherein
the degree of maintenance importance includes the degree of inconvenience indicating a level of inconvenience that occurs when a power supply is interrupted, and
making the inspection plan formation comprises calculating a priority of the identified location in regard to the inspection based on the degree of inconvenience determined for each of the identified locations, to formulate the inspection plan based on the calculated priority.

5. The facility maintenance method according to claim 2, wherein
making the inspection plan formation comprises determining an order of inspection for each of the identified locations based on the priority.

6. The facility maintenance method according to claim 2, wherein
making the inspection plan formation comprises determining whether the inspection is required for each of the identified locations based on the priority.

7. The facility maintenance method according to claim 1, wherein the facility is an electric power facility.

8. The facility maintenance method according to claim 7, wherein
making the inspection plan formation comprises calculating a priority of the identified location in regard to the inspection based on the degree of maintenance importance indicating a level of importance in maintenance determined for each of the identified locations, to formulate the inspection plan based on the calculated priority.

9. The facility maintenance method according to claim 8, wherein
the degree of maintenance importance includes the degree of security indicating a level of security required for an applicable location, and
making the inspection plan formation comprises calculating a priority of the identified location in regard to the inspection based on the degree of security determined for each of the identified locations, to formulate the inspection plan based on the calculated priority.

10. The facility maintenance method according to claim 8, wherein
the degree of maintenance importance includes the degree of inconvenience indicating a level of inconvenience that occurs when an electric power supply is interrupted, and
making the inspection plan formation comprises calculating a priority of the identified location in regard to the inspection based on the degree of inconvenience determined for each of the identified locations, to formulate the inspection plan based on the calculated priority.

11. The facility maintenance method according to claim 8, wherein
making the inspection plan formation comprises determining an order of inspection for each of the identified locations based on the priority.

12. The facility maintenance method according to claim 8, wherein
making the inspection plan formation comprises determining whether the inspection is required for each of the identified locations based on the priority.

13. The facility maintenance method according to claim 2, wherein
in the inspection plan formation, the degree of maintenance importance includes the degree of security indicating a level of security required for an applicable location and the degree of inconvenience indicating a level of inconvenience that occurs when an electric power supply is interrupted, and
based on the degree of security and the degree of inconvenience to which predetermined weights are given, making the inspection plan formation comprises calculating a priority of the identified location in regard to the inspection to formulate the inspection plan based on the calculated priority.

14. The facility maintenance method according to claim 8, wherein
in the inspection plan formation, the degree of maintenance importance includes the degree of security indicating a level of security required for an applicable location and the degree of inconvenience indicating a level of inconvenience that occurs when an electric power supply is interrupted, and
based on the degree of security and the degree of inconvenience to which predetermined weights are given, making the inspection plan formation comprises calculating a priority of the identified location in regard to the inspection to formulate the inspection plan based on the calculated priority.

15. A facility maintenance method comprising:
determining whether an event having occurred in a facility falls within a fault tree indicating known causes of occurrence of events in at least one of equipment and material in the facility;
in a case where the event is determined to fall outside the fault tree, updating the fault tree such that a cause of occurrence of the event identified through investigation is reflected;
in response to the identified cause of occurrence of the event, identifying at least either of equipment/material having an attribute similar to an attribute of equipment/material identified to relate to the cause of occurrence of the event or equipment or material including a structural element similar to a structural element identified to relate to the cause of occurrence of the event, to identify a location where the identified equipment or material is used based on installation information indicating a location where the equipment/material is installed and the attribute of the equipment or material; and
making an inspection plan formation for the identified location.
